(19) United States
(12) Patent Application Publication
(10) Pub. No.: US 2013/0152125 A1
(43) Pub. Date: Jun. 13, 2013

(54) METHOD AND SYSTEM FOR ADVERTISEMENT CHOICES USING A SECOND DISPLAY DURING CONTENT PLAYBACK

(71) Applicants: True Xiong, San Diego, CA (US); Ling Jun Wong, Champaign, IL (US); Charles McCoy, Coronado, CA (US)

(72) Inventors: True Xiong, San Diego, CA (US); Ling Jun Wong, Champaign, IL (US); Charles McCoy, Coronado, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/313,740

(22) Filed: Dec. 7, 2011

(51) Int. Cl. H04N 21/23

(52) U.S. Cl. 725/34

(57) ABSTRACT

Systems and methods are disclosed that allow users to choose ads to be delivered while viewing content. In addition, the user can choose ads using a second display, thus not interrupting content viewing on a primary device. In this way, users may receive ads or ads within specific categories of their choosing. Ad choice may also take into account ads previously viewed, user preferences and interests, any purchasing history if available (including where items are merely browsed and not purchased, or where item barcodes are scanned, e.g., by a mobile phone camera), the content item playing during ad choice, previous content items played, interests or preferences determined from a social networking profile, and the like. User data as may be compiled is useful to advertisers and provides significant benefits to users because the ads displayed are highly likely to attract user interest upon playback. User choice provides similar benefits.

### BACKGROUND OF THE INVENTION

Internet delivery of digital content to televisions such as internet-protocol televisions (IPTVs) continues to increase, as does the popularity of IPTVs themselves. Digital content delivery is often performed by content service providers, and delivery of content is generally accompanied by advertising. Current advertising delivery is driven by the content network provider or service provider, and consumers have no choice as to the advertisements (“ads”) they see. Some efforts have been made to remedy this but are limited. In some cases, the prior efforts present a choice of ads to a viewer but the ads are not user-based, and user choice information is only maintained during a single viewing session. For example, an Internet news item or video clip may be preceded by an ad choice, and subsequent ad presentation, on a one-time basis. In other cases, the viewer is only given a choice to not view a particular ad.

### SUMMARY OF THE INVENTION

Implementations of the system and method allow users to choose which ads or types of ads will be delivered and presented to them. Compiled user ad choice information may be maintained and drawn from later to inform future ads for user choice or delivery. User ad choice is not used as a gateway to viewing a content item, but rather is advantageously employed to enhance viewing of all ads during content item playback, i.e., at commercial breaks defined in content items. Users are highly interested in ads that are selected according to their tastes, or that they select themselves, and yet such ads were unavailable in the systems of the prior art. Accordingly, implementations disclosed here provide significant advantages over the prior art. In addition, in one implementation, users may choose ads, or types or categories of ads, using a second display, thus not interrupting content viewing on the primary IPTV device.

The implementations provide a way for users to receive ads of their choosing, and thus be saved the inconvenience of watching ads for which they have no interest. The way in which ad choices may be presented to a user can vary. In a broad implementation, a user can choose which categories of ads they wish to view and may further specify these by subcategory. In a more narrow implementation, a user may be presented with a choice between two ads, each ad represented by a thumbnail, a textual description, or the like. A user may also enter search terms to drive which ads they are shown or which ads are presented as choices. Combinations of these methods will also be understood. Ad choice may also take into account ads previously viewed by the user, user preferences and interests, purchasing history if available (including where items are merely browsed and not purchased, or where item barcodes are scanned, e.g., by a mobile phone camera), the content item playing during ad choice, previous content items played, interests determined from a social networking profile, and the like.

The systems and methods may be employed during the initial broadcast of a content item or during a user's time-shifted playback of a user-recorded broadcast, or in playbacks of content items that span both types. In any case, user choice can inform ad presentation; however, in the case of a playback of a user-recorded broadcast, ads may be replaced if no longer timely, e.g., includes time-sensitive content that has expired as of a current time of playback. In the same way, ads may be replaced if suboptimal considering a user's subsequent indications of ads or user data. In addition, where ads are chosen in advance of content selection, a filtering or replacement step may be employed to prevent presentation of ads which are unsuitable for the content item being played back, e.g., ads for alcohol products during children's programming, or in the converse, e.g., where content is perceived to be at odds with the image a company wishes to portray in its advertising.

Ads may be chosen even as other ads are being viewed. For example, if a user is watching a first ad but wishes to see or switch to another, they may either choose a second ad (if a choice is presented) or activate a “NEXT” button. In such cases, to accommodate the time remaining in a commercial break, an advertiser may provide a series of related ads of various lengths to allow for presentation in a variety of timeslots. Depending on the advertisement policy, the advertisement that the user skipped using the “NEXT” button may or may not count towards the amount of advertising scheduled for the current advertisement slot.

User data may be aggregated about ad choices, e.g., as tied to a user account, user profile, or the like, and the same are useful to advertisers and provide significant benefits to users because the ads displayed are highly likely to attract user interest when the same are played back. User choice provides similar user benefits. Such targeted ads may be more valuable to advertisers, and thus network providers can increase revenue by providing these targeting features and charging a higher rate, which may also make possible shorter commercial breaks.

As noted above, users may choose ads or categories using a second display, and in this way not interrupt content or ad viewing on a primary content playback device. In some cases, a content playback device may be associated with a user account while the second display is not. The second display may have been discovered using a discovery technique not associated with the user account. In such cases, the second display may still be employed for ad choice, but its choices would be communicated directly to the content playback device for subsequent transmission to an ad choice system, i.e., the second display's functionality would be similar to that of a remote control. It is important to note that the use of a second display is optional and virtually every feature and aspect disclosed herein, excepting ad choice during content playback, may be achieved without the use of a second display.

The use of second display devices in such contexts has certain benefits because the same provides complementary functionality to the IPTV, but generally does not require additional investment by the user because the same make use of a device, e.g., a smartphone, laptop computer, tablet computer, a desktop, an Internet appliance, etc., which most users would already have in their possession. Additional details about such second displays and their interactions with content playback devices, e.g., through proxy servers and otherwise, may be seen from Applicants' co-pending U.S. patent application Ser. No. 13/077,181, filed Mar. 31, 2011, entitled “PERSONALIZED SECOND DISPLAY BROWSING EXPERIENCE DUE TO MULTIPLE SESSION FEATURE”, owned by the assignee of the present invention and incorporated herein by reference in its entirety.

Where second displays are employed, the same may include any device that can run an application that communicates with a content playback device, including, but not limited to, personal computers, laptop computers, notebook computers, netbook computers, handheld computers, personal digital assistants, mobile phones, smart phones, tablet computers, hand-held gaming devices, gaming consoles, and also on devices specifically designed for these purposes, in which case the special device would include at least a processor and sufficient resources and networking capability to run the second display application.

The content playback device can take many forms, and multiple content playback devices can be coupled to and selected from within a given local network. Exemplary content playback devices may include IPTVs, DTVs, digital audio systems, or more traditional video and audio systems that have been appropriately configured for connectivity.

In a general method, including use of a second display, a user has a user account with a source or clearinghouse of services. Here, the source or clearinghouse is represented as a management server, but it should be understood that the user account may be with a service provider directly. The management server communicates with at least one content server such that the content server provides content items for presentation or access of the content item at the content playback device. The user account has information stored thereon related to what content playback devices are associated with the user account. When a user logs on, they may see this list of content playback devices and may choose a particular content playback device. If there is only one content playback device on the network, or if the user is browsing in a way that the content playback device identity is not needed, then this step may be omitted. Once a content playback device has been chosen, a list of services may be displayed from which the user may choose. From a chosen service, a user may select a content item for viewing, undergoing an affiliation or authentication step if required by the service. Additional details may be found in the application incorporated by reference above.

In one aspect, the invention is directed to a server-based method of selecting an ad for playback on a content playback device during a commercial break of a content item, including: receiving information about a content item, the content item having defined at least one commercial break; receiving a user indication of an ad or user data; selecting an ad based on the received user indication or user data; and sending a signal to cause the selected ad to be delivered to the content playback device for playback during a commercial break in the content item.

Implementations of the invention may include one or more of the following. The receiving a user indication of an ad may include receiving a choice of an ad from a plurality of displayed ads, and the selecting an ad based on the received user indication may include selecting an ad corresponding to the choice. The selecting an ad may be based on both a received user indication and user data. The receiving information and the receiving a user indication may include receiving information from a user of the content playback device. The steps of receiving information and receiving a user indication of an ad or user data may be facilitated by utilization of a second display. The method may further include causing playback of the content item with the selected ad played back during a commercial break. The selecting an ad may further include selecting the ad based on the received information about the content item. The user indication of an ad or user data may be received before the information about the content item, and may further include: determining if the selected ad is suitable for the content item, and if so, sending a signal to cause the selected ad to be delivered, and if not, sending a signal to cause a replacement ad to be delivered; or selecting the ad based on an additional criterion, the additional criterion being metadata associated with the content item. The receiving a user indication of an ad or user data may include receiving a user indication of an ad during a time when a first ad is being played back on the content playback device, and may further include: selecting a second ad based on the received user indication and a time remaining in the commercial break; and causing the selected second ad to be delivered to the content playback device. The method may further include causing playback of the first ad to stop prior to the causing the selected second ad to be delivered to the content playback device. The receiving a user indication of an ad or user data may further include receiving a user indication of an ad or user data from a social networking site. The receiving a user indication of an ad or user data may further include receiving user data of a type selected from the group consisting of: a user purchasing or browsing history, a prior user ad choice, a prior user indication of an ad, a previously-viewed content item, a user preference or interest, a barcode scanned by the user, a preferred ad length, an average ad length previously viewed or selected by a user, a date, time of day, or time zone of a user, a user location, or a combination of the above. The receiving a user indication of an ad or user data may further include receiving a user indication of an ad or user data from a second display, the second display at least partially configured to control content item presentation on the content playback device. The second display may be at least partially configured to control content item presentation on the content playback device through a proxy server. The receiving a user indication of an ad or user data may occur during playback of a content item on the content playback device. The receiving a user indication of an ad or user data may occur prior to playback of the content item on the content playback device, and the receiving a user indication of an ad or user data may further include receiving user indication of an ad or user data from a user interface on the content playback device. The receiving a user indication of an ad may include receiving category information from a user, the category information indicating categories of products or services, or may include receiving keyword information from a user, the keyword information indicating products or services. The method may further include receiving a notification that a user is playing back a recorded content item at a current time, and may further include: determining if ads in the recorded content item are timely, and if ads in the recorded content item are not timely, selecting one or more ads that are timely to be selected and causing the one or more timely ads to be delivered to the content playback device to replace the untimely ads, an ad being timely when included time-sensitive content has not expired as of the current time; or determining if ads in the recorded content item are optimal, an ad being optimal when selected on a basis of user indications, user data, or using criteria as of the current time, and if ads in the recorded content item are suboptimal, selecting one or more ads that are optimal and causing the one or more optimal ads to be delivered to the content playback device to replace the suboptimal ads.

In another aspect, the invention is directed to a non-transitory computer-readable medium, including instructions for causing a computing device to implement the above method.

In a further aspect, the invention is directed to a server-based method of selecting an ad for playback on a content playback device during playback of a recorded content item, including: receiving a notification from a user of the content playback device that the user is playing back a recorded content item at a current time; determining if ads in the recorded content item are timely, and if ads in the recorded content item are not timely, selecting one or more ads that are timely and causing the one or more selected timely ads to be delivered to the content playback device to replace the untimely ads, an ad being timely when included time-sensitive content has not expired as of the current time; or determining if ads in the recorded content item are optimal, an ad being optimal when selected on a basis of user indications, user data, or using criteria as of the current time, and if ads in the recorded content item are suboptimal, selecting one or more ads that are optimal and causing the one or more selected optimal ads to be delivered to the content playback device to replace the suboptimal ads.

Implementations of the invention may include one or more of the following. The method may further include receiving a user indication of an ad or user data, and where the one or more ads that are timely or the one or more ads that are optimal are selected based at least in part on the recorded content item and on the received user indication of an ad or user data. The method may further include receiving user data of a type selected from the group consisting of a user purchasing or browsing history, a prior user ad choice, a prior user indication of an ad, a previously-viewed content item, a user preference or interest, user data from an external site, a barcode scanned by the user, or a combination of the above. The method may further include receiving the user indication of an ad or user data from a second display, the second display at least partially configured to control content item presentation on the content playback device.

In another aspect, the invention is directed to a non-transitory computer-readable medium, including instructions for causing a computing device to implement the above method.

In another aspect, the invention is directed to a second display system for providing advertising based on user choice, including: an input module configured to receive a user indication of an ad; a second display advertising choice module configured to receive and store user data about online browsing or shopping and to receive the user indication from the input module; and a network communications module configured to receive data from the second display advertising choice module and transmit the received data to a management server or ad server.

In another aspect, the invention is directed to a server system for providing advertising based on user choice, including: a network communications module configured to receive and transmit data, the network communications module including: a communications module configured to communicate with an ad choice application, the communications module configured to receive a user indication of an ad and configured to transmit at least potential ad choices or ad categories; a content playback device communications module configured to communicate and deliver or cause to be delivered ads for playback on a content playback device; and an external site communications module configured to communicate with and receive user data from at least one external site; an advertising choice server module configured to receive a user indication of an ad or user data from the network communications module and to either select an ad based on the received data or to create criteria sufficient for selection of one or more ads, the advertising choice server module including a content suitability module configured to determine if an ad is suitable for playback during playback of a content item; and an ordering and delivery module configured to order ads based at least partially on the user indication of an ad or the user data or both, and to deliver or cause to be delivered one or more of the ordered ads to a content playback device through the content playback device communications module.

Implementations of the invention may include one or more of the following. The advertising choice server module may further include a timeliness module configured to, upon playback of a recorded content item at a current time, determine if a recorded ad is timely and to replace the ad if it is not timely, an ad being timely when included time-sensitive content has not expired as of the current time. The advertising choice server module may further include an optimality module configured to, upon playback of a recorded content item at a current time, determine if a recorded ad is optimal, an ad being optimal when selected on a basis of user indications, user data, or using criteria as of the current time, and to replace the ad if it is suboptimal. The server may be a management server or an advertising server. The external site communications module may be configured to communicate with a social networking site or an online shopping site. The external site communications module may be configured to receive a feed from a user profile on the social networking site. The feed may include data selected from the group consisting of: preferences and interests, groups, friends' interests and preferences, and combinations of these. The external site communications module may be configured to provide a feed to a user profile on the social networking site.

In another aspect, the invention is directed to a server system for providing advertising to a user based on user choice, including: memory bearing computer-readable instructions capable of establishing a user account session between a server and a device running an ad choice application; memory bearing computer-readable instructions capable of receiving user data or a user indication about an ad; memory bearing computer-readable instructions capable of receiving user data from an external site; memory bearing computer-readable instructions capable of using the received user data or user indication to select an ad; and memory bearing computer-readable instructions capable of delivering, or causing to be delivered, the selected ad to a content playback device associated with the user account during playback of a content item.

Advantages of certain implementations of the system and method may include one or more of the following. Ads or categories of ads may be chosen by a user for delivery and presentation at a regular commercial slot on a content playback device such as an IPTV. The ads may be chosen during content playback or in advance of any content playback. Especially, though not exclusively, where ads are chosen during content playback, the same may be selected using a second display device, thus not interrupting playback on the content playback device.

Other advantages will be apparent from the description that follows, including the figures and claims.

### BRIEF DESCRIPTION OF THE DRAWINGS

Like reference numerals denote like elements throughout.

FIG. 1 is a block diagram of an exemplary system in accordance with an aspect of the present principles, illustrating a remote control for operating an ad choice application on a content playback device.

FIG. 2 is a block diagram of another exemplary system in accordance with an aspect of the present principles, illustrating various second displays for operating ad choice applications to control advertising on a content playback device.

FIG. 3 is a flowchart illustrating an exemplary method according to another aspect of the present principles, the method for determining one or more ads within various sets of ads.

FIG. 4 is a flowchart illustrating an exemplary method according to another aspect of the present principles, the method for delivering an ad indicated by a user, and/or based on user data, during an initial broadcast of a content item.

FIG. 5 is a flowchart illustrating an exemplary method according to another aspect of the present principles, the method for delivering an ad indicated by a user, and/or based on user data, during playback of a user-recorded broadcast of a content item.

FIG. 6 is a table illustrating a number of ads and applied criteria, which may be stored as metadata, and which may be employed to prioritize the ads for delivery.

FIG. 7 is a functional block diagram of an exemplary modular second display system in accordance with another aspect of the present principles.

FIG. 8 is a block diagram of an exemplary modular server system in accordance with another aspect of the present principles.

FIG. 9 is a block diagram of an exemplary server system in accordance with another aspect of the present principles.

FIG. 10 illustrates an exemplary computing environment, e.g., that of the disclosed second display, management server, or ad server.

### DETAILED DESCRIPTION

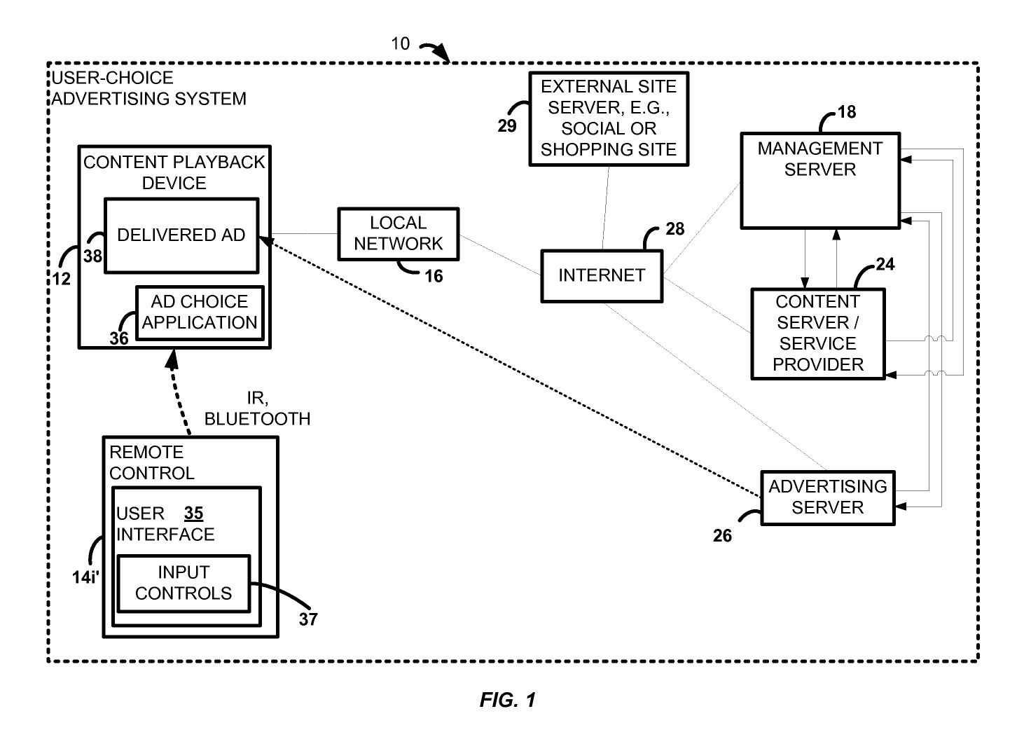

Referring to FIG. 1, a system 10 is shown including a content playback device 12 coupled to a local network 16, which may be wired, wireless, or a combination of both. Also coupled to the local network 16 are one or more remote controls 14′, which may be of any type capable of providing input to the content playback device 12 in order to control a user interface having various menu options.

A number of servers may be accessed by the content playback device 12 through the local network 16 and the Internet 28, including a management server 18 and one or more content servers 24 corresponding to service providers (only one is shown in FIG. 1). The servers, in particular the management server 18, may communicate with an advertising server 26 to enable ads 38 to be delivered along with provided content items to the content playback device 12.

In one implementation, the remote control 14′ has a user interface 35 with various input controls 37. Such input controls typically include arrow keys, a selection function, and in some implementations a capability for text entry for searching or the like. The remote control 14′controls an ad choice application 36 running on the content playback device 12. Through the ad choice application 36, the user can be presented with a way to indicate ads they wish to see as described below. These user indications may include choices of ads, in which case the user may select from ads by perusing descriptions, thumbnails, previews, or the like, as displayed on the content playback device 12. The user indications may also include preferences for ads, which may include categories and subcategories of ads that the user has selected as being desired. Such categories and subcategories may be indicated by checkboxes on a menu displayed on the content playback device 12, by keywords entered, and in other like manners. The user indicates their selections using the input controls 37 on the user interface 35.

Information or data on which delivered ads are based may include more than just user input to the ad choice application 36. For example, information may be retrieved, culled or gleaned from an external site 29, such as a social networking site or an online shopping site. In one exemplary implementation, user preferences or interests expressed in a social networking site may be employed to inform choice of a set of ads presented to a user. Various other ways may also be provided, as will be understood, such as barcodes scanned by the user using the mobile device 32.

With the system 10 of FIG. 1, the user is provided with a convenient and flexible way to choose ads. Such supports a superior experience for the user because if the user chooses an ad to watch, or if the ad is chosen by the system based on known user preferences and interests, then that ad is highly targeted to that user and the user is much more likely to pay attention to the ad. Since the ad is highly targeted and more likely to be watched closely, the ad playback will likewise be more valuable to the advertiser and potentially allow a higher rate to be charged for each ad shown, thus maximizing the value of the advertising breaks in content, allowing higher ad revenue, and/or shorter commercial breaks.

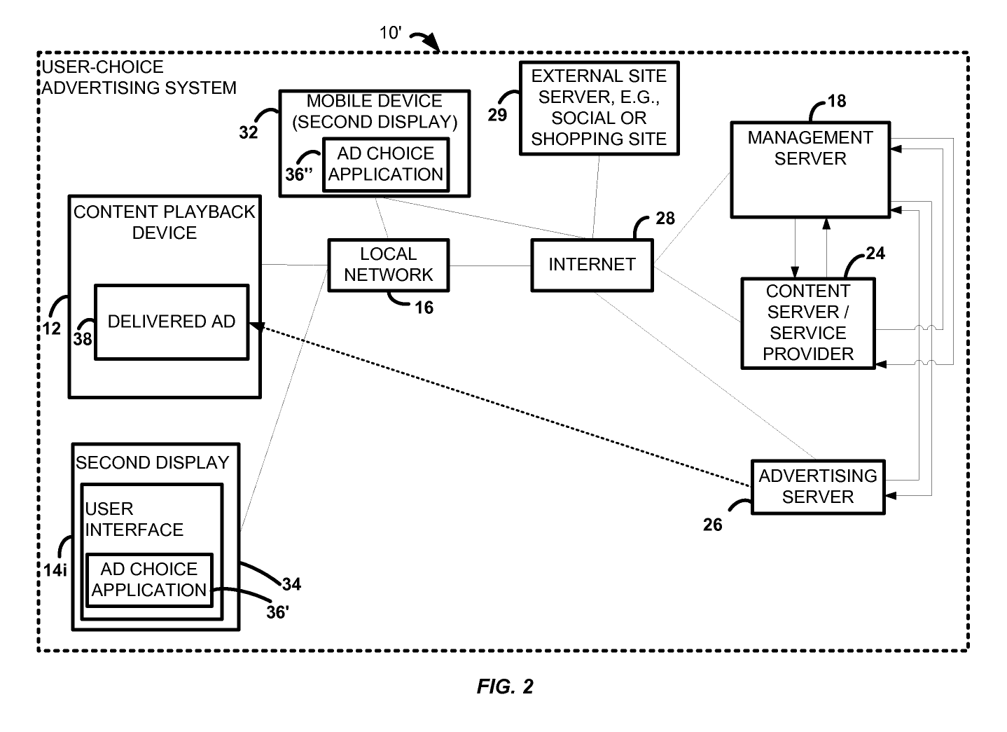

Another implementation is illustrated in FIG. 2, in which a system 10′ is shown in which the content playback device 12 is coupled to the local network 16, which may take the forms noted above. Also coupled to the local network 16 are one or more second displays, an exemplary one being shown as second display 14i. The second display 14i may in some cases be a laptop, tablet, handheld computer, or other Internet appliance, or may include a mobile device 32 such as a smart phone, which as shown may be directly connected to the Internet 28 or to the local network 16, or both. Other types of second displays will also be understood, including desktop computers or the like.

As indicated in FIG. 2, a number of servers may be accessed by the content playback device 12 and the second display 14i through the local network 16 and the Internet 28, including a management server 18 and one or more content servers 24 corresponding to service providers. The servers, in particular the management server 18, may communicate with an advertising server 26 to enable ads 38 to be delivered along with provided content items to the content playback device 12.

In one implementation, the second display 14i includes a user interface 34 on which a user may operate a second display ad choice application 36′. The mobile device second display 32 is also illustrated with an ad choice application 36″, which is a suitable mobile version of the ad choice application 36. Through the ad choice application 36, the user can be presented with a way to indicate ads they wish to see. These user indications may include choices of specific ads, in which case the user may select ads by perusing descriptions, thumbnails, previews, or the like, and the same may be displayed on the content playback device 12 or on the second display 14i. The user indications may also include preferences for ads, which may include categories and subcategories of ads that the user has selected as being desired. Such categories and subcategories may be indicated by checkboxes on a menu, by keywords, and in other like manners. Because the ad indications are registered on a second display, it is not necessary to interrupt playback of content on a content playback device to make such choices.

As in FIG. 1, information may also be retrieved, culled or gleaned from an external site 29, such as a social networking site or an online shopping site, via barcodes scanned by the user using the mobile device 32, or by other means.

It is noted that in the system of FIG. 2, it is not necessary that all functionality of the ad choice application reside on the second display. Rather, some functional modules of the ad choice application may reside on the content playback device and other cooperating modules may reside on the second display.

It is noted again that most of the functionality of the system 10′ of FIG. 2 will also be present in the system 10 of FIG. 1, excepting content playback during ad choice selection. Such includes: compiling user ad choice information to be maintained and drawn from later to inform future ads for user choice or delivery, user choice of specific ads, user choice of categories or styles of ads, the presentation to users of ads using thumbnails or textual descriptions, the use of keywords to drive ad choice, and the use of any of the following to drive ad choice: historic user ad choice or purchasing behavior, user preferences and interests, social networking profile information, user product interest indicated by scanned barcodes or the like, and so on.

Details of individual components are now described, followed by a description of the advertising system, including exemplary methods and components. It is noted that the methods for ad choice may be implemented on a management server, a proxy server as described in the patent application incorporated by reference above, an ad server, on a server dedicated for these purposes, or on combinations of these. Certain of the functionality may even be incorporated on a second display.

The content playback device 12 may be, e.g., an IPTV, a digital TV, a digital sound system, a digital entertainment system, a digital video recorder, a video disc player, a combination of these, or any number of other electronic devices addressable by a user on the local network 16 and capable of delivering an ad over the Internet. For the sake of simplicity, in this specification, the content playback device 12 will generally be exemplified by an IPTV, in which case the same will generally include a processor that controls a visual display and an audio renderer such as a sound processor and one or more speakers. The processor may access one or more computer-readable storage media such as but not limited to RAM-based storage, e.g., a chip implementing dynamic random access memory (DRAM), flash memory, or disk-based storage. Software code implementing present logic executable by the content playback device 12 may also be stored on various memories to undertake present principles. The processor can receive user input signals from various input devices including a second display, a remote control device, a point-and-click device such as a mouse, a keypad, etc. A TV tuner may be provided in some implementations, particularly when the content playback device 12 is an IPTV, to receive TV signals from a source such as a set-top box, satellite receiver, cable head end, terrestrial TV signal antenna, etc. Signals from the tuner are then sent to the processor for presentation on the display and sound system. A network interface such as a wired or wireless modem communicates with the processor to provide connectivity to the Internet through the local network 16. It will be understood that communications between the content playback device 12 and the Internet 28, or between the second display 14i and the Internet, may also take place through means besides the local network 16. For example, the second display 14i may communicate with the content playback device 12 through a separate mobile network.

The one or more second displays 14i each bear a processor and components necessary to operate an application for service provider, content, and ad selection, variations of which are described below. In particular, the processor in the second display may access one or more computer-readable storage media such as but not limited to RAM-based storage, e.g., a chip implementing dynamic random access memory (DRAM), flash memory, or disk-based storage. Software code implementing present logic executable by the second display may also be stored on various memories to undertake present principles. The second display 14i can receive user input signals from various input devices including a point-and-click device such as a mouse, a keypad, a touch screen, a remote control, etc. A network interface such as a wired or wireless modem communicates with the processor to provide connectivity to wide area networks such as the Internet 28 as noted above.

The servers 18, 24, and 26 have respective processors accessing respective computer-readable storage media which may be, without limitation, disk-based and/or solid state storage. The servers communicate with a wide area network such as the Internet 28 via respective network interfaces. The servers may mutually communicate via the Internet 28. In some implementations, two or more of the servers may be located on the same local network, in which case they may communicate with each other through the local network without accessing the Internet.

Methods associated with an ad choice system are now described.

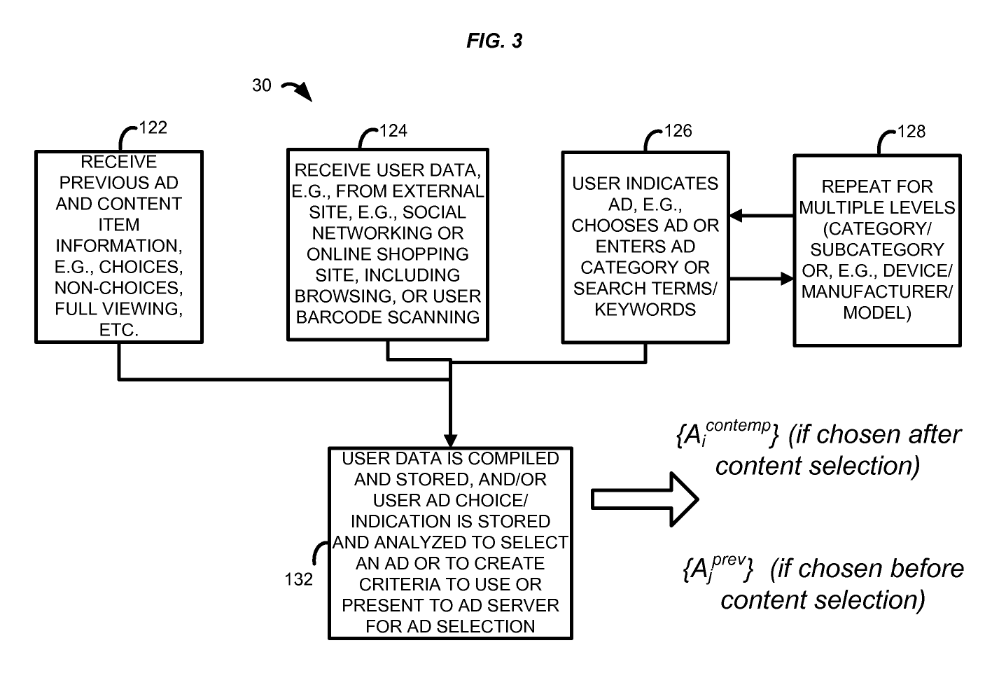

FIG. 3 illustrates an exemplary method 30 by which user data or user indications of ads may be received for use in the ad choice application. In the method 30, a number of data sources are illustrated; it will be understood that in any given implementation a subset of these may be employed. Not all are required, and other sources may also be leveraged.

In the method 30, one step is to receive information about previously viewed ad or content item choices (step 122). It will be understood the same may be provided from different sources, e.g., previous ad choices from an ad server and previous content item choices from a management server or service provider. This information may not only include affirmative choices, where a user has viewed an entire ad or content item, but also where a user has indicated a desire to not watch the ad or content item. The information from step 122 may be passive, in which case it is simply recorded if a user has viewed a content item or ad, or may be active, where a user has affirmatively given an indication about a content item or ad, e.g., by indicating they “LIKE” the same or have given it a positive rating, e.g., in a query posed by the management server. “NOT LIKE” indications or negative ratings may also be used as the information 122.

Another step in the method 30 is to receive user data as retrieved, culled or gleaned or otherwise obtained from an external site, e.g., a social networking site or an online shopping site (step 124). For example, if a user has indicated in their user profile for the social networking site a desire for a given product, the same may be used as a basis for delivering an ad to the user for the product or for a related product. In the same way, if a user “LIKEs” a product listed on their own or a friend's profile, the same may be used for similar purposes. Data may also be retrieved from user preferences and interests for this purpose; in this sense the user preferences and interests may be from not only external sites but also from sites supported on the management server.

A further source noted in the method 30 of FIG. 3 is a user indication of an ad (step 126). In this usage, a user may indicate an ad in a number of ways. For example, a user may be given a choice between two or more ads to watch. The ads may be indicated by thumbnails, previews, textual descriptions, or the like. Where the initial set of ads is generic, e.g., listing ads to different manufacturers, a subsequent step may be provided to narrow down the choices, e.g., to receive user input on models of goods provided by those manufacturers (step 128).

In another way of providing a user indication, a user may also be given a set of subject matter categories from which to choose ads. For example, a user may choose one or more categories such as: automobiles, sporting goods, movies, applications, beverages, and so on. After providing the categories, the user may then further specifies his/her selection to subcategories (step 128) in the same way as noted above. Combinations of the above steps may also be noted, e.g., a user may choose between manufacturers, and then choose a particular ad to view. This step 128 may be repeated any number of times until a user is satisfied with the sub categorization or the user has chosen a particular ad.

In any case, a subsequent step is that user data is compiled and stored, and/or the user indication is stored, and the same analyzed to select an ad or to create criteria to employ for ad selection or to present to an ad server for ad selection (step 132). User indications and user data will generally change over time, and at any given time, the latest or current user indications and/or user data, or latest or current criteria, may be employed for selections. The compiled data may be stored on the management server, proxy server, ad server, or the like. Where not stored on an ad server, the ad choice or criteria may be presented to an ad server to cause delivery of ads when required. It is further noted that treatment of ad choices may differ depending on when ads are chosen with respect to content selection. For convenience in this specification, a set of ads selected is denoted by {Aᵢ^{contemp}} if determined following content selection, and {Aⱼ^{prev}} if determined prior to content selection. Details of the different treatments are described below.

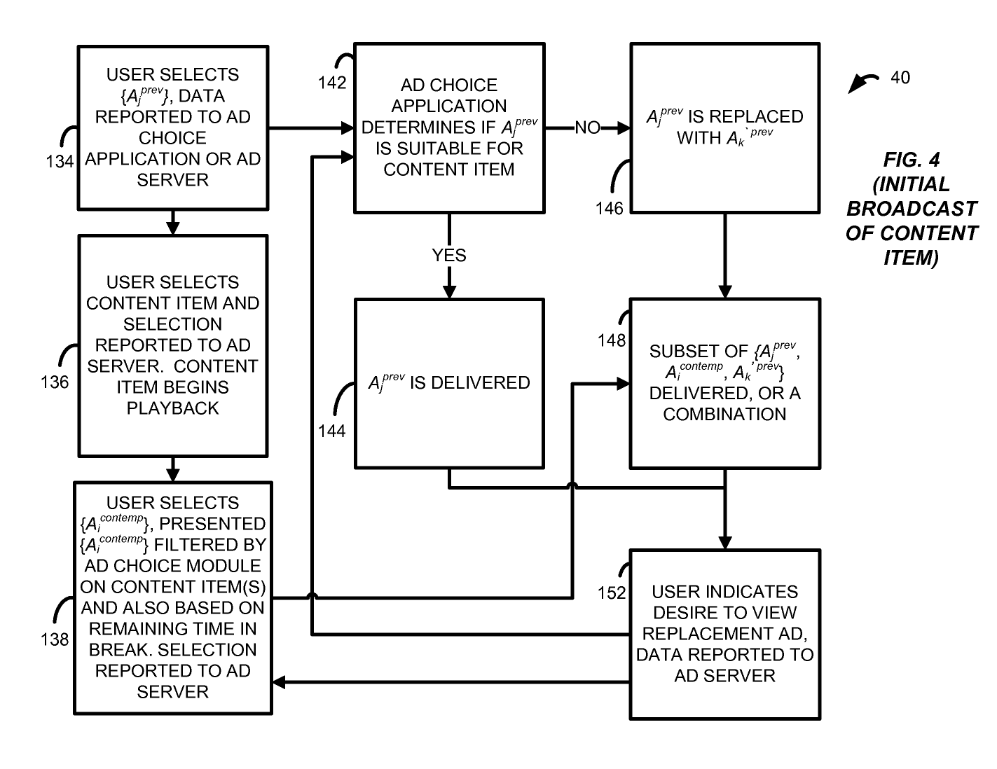

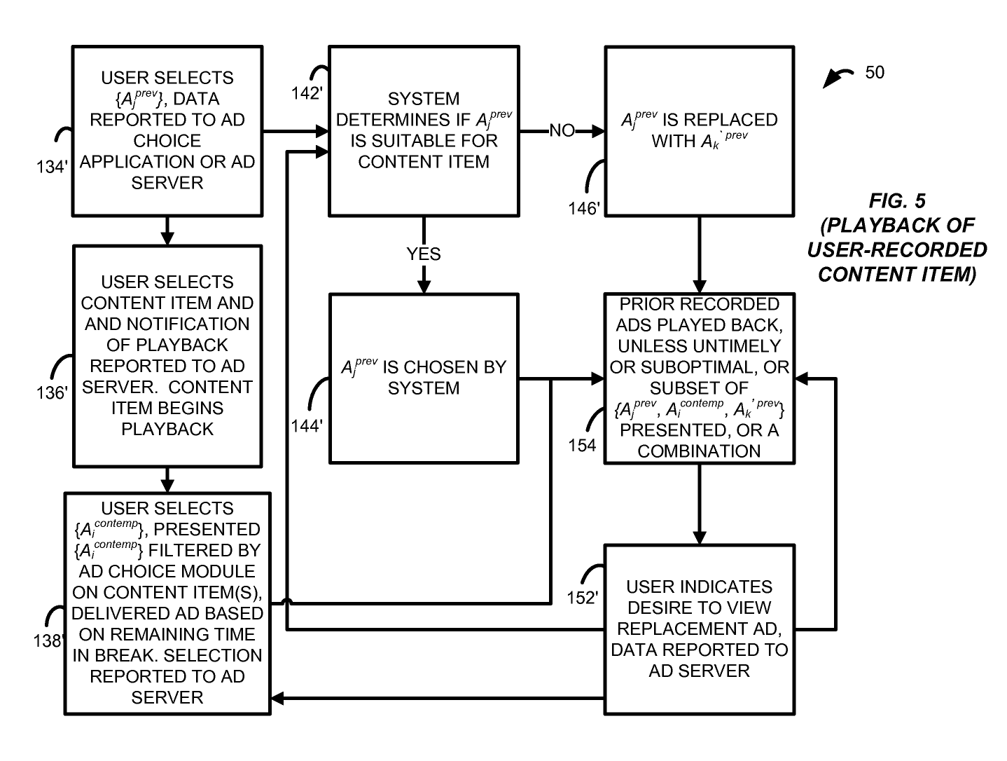

FIGS. 4 and 5 illustrate flowcharts by which methods according to the principles disclosed here may be implemented. In FIG. 4, a flowchart 40 is shown in which advertising choices may be provided during an initial broadcast of a content item. In FIG. 5, a flowchart 50 is shown in which the advertising choices are provided during a playback of a user-recorded broadcast content item, e.g., one that has been recorded by the user for purposes of time-shifted viewing. In both cases, user choice can inform ad presentation; however, in the latter, ads recorded along with the content item may be replaced if no longer timely or if the ads are in some way suboptimal, taking into account user activity occurring between the time of the content item recording and the time of playback. In FIGS. 4 and 5, the set notation {Aⱼ^{prev}} and {Aᵢ^{contemp}} is provided for convenience. In addition, several of the component steps in FIG. 5 are similar to those in FIG. 4, and these have been notated with primed reference numerals. In any given implementation, either {Aⱼ^{prev}} or {Aᵢ^{contemp}} or both may be provided and employed.

Referring to FIG. 4, a first step is that a user may provide various indications of ads, and/or user data may be collected, before any sort of content is selected, the content either for individual playback or as part of a playlist (step 134). The resulting set of ads, which may be a static set of ads, a set of criteria to apply against a database on an ad server, or a combination of these, is denoted by {Aⱼ^{prev}}. If stored as a set of criteria, the set is dynamic because ads that meet the criteria may be added or removed from the ad server. Data used in constructing the set, and the set itself, may be stored with the user account information on the management server or on the ad server. A next step is that a user selects a content item (step 136). If the content item is part of a playlist, the playlist may be started or resumed. Data about the content item(s) may likewise be reported to the advertising choice application.

Following selection of the content item, a contemporaneous set of potential ads to present to the user may be developed, e.g., {Aᵢ^{contemp}}, and user selection may occur from these ads (step 138). {Aᵢ^{contemp}} are generally indicated by the user following content selection. Accordingly, the same may be especially appropriate to be gained by the process of step 126, where a user can indicate an ad substantially in the same timeframe in which it may be delivered. Of course, it will be understood that data from steps 122 and 124 may also be employed in generating the selection of potential ads. In generating {Aᵢ^{contemp}}, the advertising choice application will generally have been sent information about the content item(s) being watched; accordingly, {Aᵢ^{contemp}} may be based on this content item. In other words, {Aᵢ^{contemp}} may be constructed such that ads do not appear which are unsuitable for the content item(s) being presented. That is, a user will not be given a set of ads to choose from where the ads are unsuitable for the content item(s). In a specific example, during children's programming, the user may not be given a set of ads for alcohol products from which to choose.

This is in contrast to the case of {Aⱼ^{prev}}, this set being determined prior to content selection. {Aⱼ^{prev}}, not being based on the content item(s), may include any ads or categories for which the user has indicated an interest. {Aⱼ^{prev}} may also include ads generated from any of the steps in the flowchart 30 of FIG. 3. Accordingly, the same may include ads unsuitable for viewing during presentation of the content item(s). For this reason, a next step is that the advertising choice application determines if {Aⱼ^{prev}} is suitable for the content item (step 142). If so, one of the {Aⱼ^{prev}} may be delivered (step 144) at a commercial break. If not, the particular Aⱼ^{prev} is filtered out and replaced with a A′ₖ^{prev} that is suitable for the content item (step 146).

The test of whether an ad is suitable for a content item may be implemented by a rule set acting on metadata associated with the content item and with the ad. Such a rule set may be in place because of restrictions from either the content side, e.g., a children's content provider may not want mature ads, or from the advertiser's side, e.g., an advertiser may not wish to have its ad appear in a content item that may be at odds with the company's image. Other such rules will also be seen, including subject matter rules. For example, an ad may be chosen by a user while watching a content item concerning home improvement. If the user switches the channel to watch a content item concerning cooking, the ad chosen during the home improvement content item, now part of {Aⱼ^{prev}}, may be deemed to be unsuitable for delivery and presentation during the cooking content item. Such rule sets may be provided by default, although the same may also be user-modifiable.

Once an appropriate Aⱼ^{prev}, A′ₖ^{prev} or Aᵢ^{comtemp} is determined, one or more of the same may be delivered for viewing on the content playback device (step 148). It will be understood that ads from {Aⱼ^{prev}}, {A′ₖ^{prev}}, and {Aᵢ^{comtemp}} may be delivered in any combination. In addition, ads not chosen by the user may in some cases also be delivered and presented, especially where chosen or indicated ads do not occupy an entire time available for a commercial break. Ads not chosen by the user may be chosen by the system taking into account any category/subcategory of information provided by the user, or any data received in steps 122 or 124. The advertising choice application may be configured to weight some factors more than others according to a desired outcome. Certain of such ads may be given preference for delivery if the advertiser pays an additional fee or by other considerations. In this way, a user may be exposed or recommended to additional products for which it is likely he/she will have an interest.

A step that may be included in any ad determination step is to determine if a selected ad is of a correct length to fit in a time remaining in a commercial break. To ensure an ad will fit in the allotted time, a series of related ads may be created of differing lengths. In this way, if an ad is selected or indicated by a user, an ad of proper length may be presented without running over the available commercial break time. Where no ads have been delivered for a given break, the “remaining time” is the entirety of the break. Where ads have been delivered already, or where step 152 occurs as described below, the “remaining time” is the total break time minus the time duration of ads already delivered in the break, including partial ads.

A further step within the method 40 is that a user may indicate a desire to view a replacement ad (step 152), e.g., if a currently viewed ad is not desirable or of less interest to them. Such an indication may even occur as a user is viewing a first ad, in which case delivery or playback of the first ad is stopped and a second ad delivered and played back. The flow may proceed to step 138 for delivery of a substantially contemporaneously-chosen ad or to step 142 for delivery of a previously-chosen ad. In one specific implementation, where a user has selected a specific ad as the “next” or replacement or second ad, step 138 may occur; where a user has simply indicated a desire to view any “next” or replacement ad, step 142 may occur. It will be understood that numerous variations of these may be employed. For example, the “next” or replacement ad may be chosen to include related ads from the same company, director, actor, actress, soundtrack, or the like. One use case may be that a user has great interest in the music in the ad video, but nothing else. The interest may lie in the genre, artist, band, record company, or the like. Where step 152 occurs, it is generally particularly important to ensure the “next”, replacement or second ad will fit in the time remaining in the commercial break. Advertisers may provide a series of related ads having varying lengths to accommodate various times remaining in commercial breaks.

In one specific implementation, which may be employed along with any of the arrangements disclosed here, the system may be configured to allow users to preselect ads such that they have a queue of ad choices. When the user watches content, after the content is chosen, they can be presented with the option to select ads for viewing during that playback in any manner as described. These ad choices may be tailored to only include ads that are appropriate for the chosen content. If the user does not select enough ads to fill all of the slots available in the content, the system will first attempt to fill the empty slots with appropriate ad choices from the user's queue. Such choices may be prioritized either by the order in which they were placed in the queue, by their fit with the chosen content, or by other criteria. In the case where there are not enough ads in the user's queue to fill such slots, the system may choose ads to fill the remaining empty slots taking into account the content viewed as well as general ad preferences, including product categories or ad styles, which are explicitly stated by the user or which are inferred by the system in any manner described above.

FIG. 5 illustrates a situation where the advertising choices are provided during a user-initiated playback of a previously-recorded broadcast content item. In this situation, a set of {Aⱼ^{prev}} will have been recorded along with the content item. As detailed in FIG. 5, the same may be played back along with the content item, or replaced as needed. In the various cases, all of the ads may be replaced, none of the ads may be replaced, or certain of the ads may be replaced.

The first steps in the method illustrated by the flowchart 50 are similar to those described above in connection with FIG. 4, and these are indicated by their prime counterparts. {Aⱼ^{prev}} is determined in step 134′, and a user selects a content item for playback in step 136′; in this case, the content item has been user-recorded. During playback, the user may select {Aᵢ^{comtemp}} (step 138′), which are filtered as described above. In addition, the system determines if {Aⱼ^{prev}} is appropriate for the content item in step 142′, and either chooses the same for playback in step 144′or replaces {Aⱼ^{prev}} with {A′ₖ^{prev}} in step 146′.

Ads recorded along with the initial broadcast may then be played back, unless untimely or suboptimal as described below, or a subset of {Aⱼ^{prev}}, {A′ₖ^{prev}}, {Aᵢ^{contemp}} delivered, or any combination of these in step 154. In this usage, an untimely ad is generally an ad that includes time-sensitive content that has expired as of a current time of playback, e.g., content that was appropriate at the time of the initial broadcast of the content item but is no longer appropriate given the time of playback. In one particular example, an ad may refer to an upcoming television program, but at the time of playback, the program may have already aired. Where an ad has been determined to be untimely, the same may be filtered out and a replacement ad selected in any of the manners described above, and the same delivered in place of the untimely ad.

A suboptimal ad is one that was of a suitable priority and preference to be aired during the initial broadcast, according to user indications and ad choices at the time of broadcast and recording, but has since lowered in priority and preference given subsequent user activity between the time of the recording of the content item and its playback. For example, subsequent to the content item recording, a user may have expressed great interest in obtaining an HDTV. Consequently, ads for HDTVs may occupy a higher priority in ad choice for the user, making other ads suboptimal. Where an ad has been determined to be suboptimal, a replacement ad may be selected in any of the manners described above, and delivered in place of the suboptimal ad.

As noted above, the choice of ads seen by the user, which may include user-recorded ads and/or a subset of {Aⱼ^{prev}}, {A′ₖ^{prev}}, and {Aᵢ^{contemp}}, may be based on a number of factors as have been described, including weightings of these factors. The set of factors, and their weightings, may be chosen according to any desired goal to be accomplished by the system. Finally, as in FIG. 4, a user may indicate a desire to view a replacement ad in step 152′, and flow proceeds similarly.

It is noted with regard to FIG. 5 that the system and method may apply to any recorded content, whether or not the user actively recorded the same. For example, in some current systems, users may watch content that was recently broadcast, even if they did nothing to record the content when it was broadcast. In this situation, the content may be considered “system recorded”. Therefore term “recorded” is intended to apply to user-recorded content as well as any such content that is recorded without any user involvement and then made available to the user for playback. In “system recorded” content, the ads may be personalized to the user at the time of playback, as user information will be known at that point (but would not have necessarily been known when the content was initially recorded).

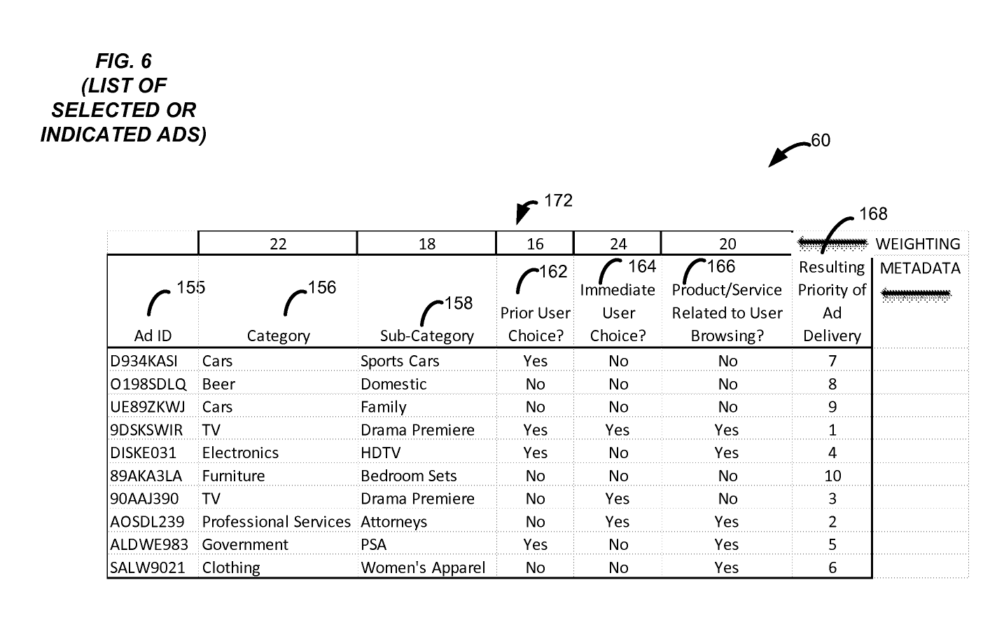

FIG. 6 illustrates a table 60 which lists a number of advertisements along with their ad ID 155, category 156, subcategory 158, an indication 162 as to whether they've been chosen previously, an indication 164 as to whether a user has chosen them contemporaneously, and an indication 166 as to whether they are related to user browsing. Clearly, it will be understood that the table 60 is purely exemplary, and may include many other factors, including whether a manufacturer has paid for ad delivery, whether a user has scanned a barcode related to a product, a user purchasing history, the lengths of available ads, and the like. The table 60 also includes exemplary weightings 172. By an algorithm including the factors 156-166 and weightings 172, a priority 168 of ad delivery may result as is displayed in the final column 168. Accordingly, in this example, advertisement “9DKSWIR” would be delivered first, followed by advertisement “AOSDL239”, advertisement “90AAJ390”, and so.

Aspects of various components of the ad choice system are described below.

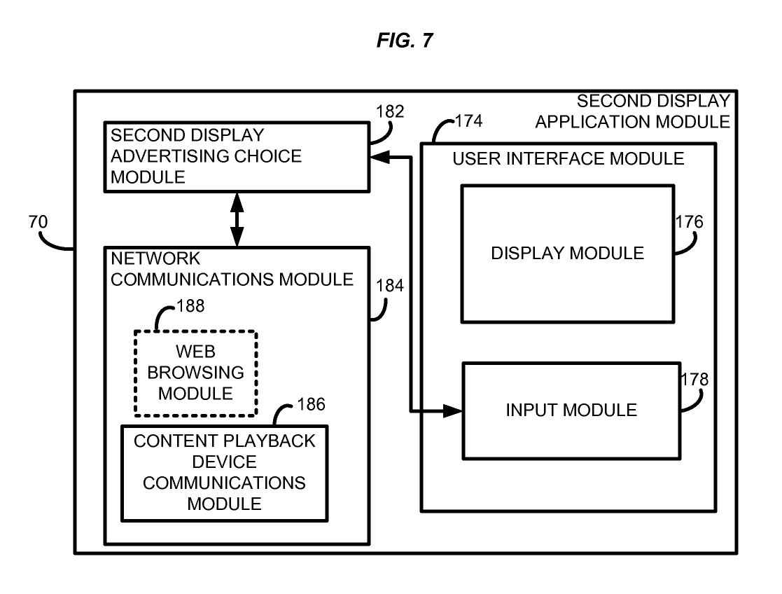

FIG. 7 illustrates one modular implementation of a second display 70. The second display 70 includes a user interface module 174 including a display module 176 for use in, among other aspects, displaying services, content playback devices, ad choices, categories, search fields, content item choices, and the like. The user interface module 174 may also include an input module 178 for the user to input ad choices, indications of ads, search terms, and the like. The input module 178 may also be employed for selecting content items, services, content playback devices, and so on.

User input into the input module 178 may be reflected in the display module 176 and also provided to a second display advertising choice module 182. From the second display advertising choice module 182, data may be sent to an ad server, or other server hosting an advertising choice server application, through the network communications module 184. The second display advertising choice module 182 not only serves the purpose of receiving user input but may also in some implementations also compile and transmit information and data from user interaction with an external site such as a social networking site or online shopping site. In other implementations, such information and data may be provided directly to a management server or ad server.

In some implementations, the display module 176 may be a module that produces an output signal for display by another device. In this case, the actual display is external to the second display itself For example, in the case of a Blu-ray® player being used as a second display, the display module 176 would be a unit that produces, e.g., an HDMI output signal, while the actual display is performed by the TV that is connected to that HDMI output.

The second display 70 also includes a module 184 for network communications. The network communications module 184 allows the second display to communicate with the local network as well as, in some cases, specific devices directly. Through the network communications module, the second display may communicate information and data from a second display ad choice module 182 to a management server or ad server or other server hosting an advertising choice server application. As part of the network communications module 184, a communications module 186 for communications with a content playback device is provided. The content playback device communications module 186 allows the second display to communicate with the content playback device either over the local network, via the Internet, or directly. Such direct communications may include various types of wired or wireless transmission schemes, including Wi-Fi, USB, infrared, Bluetooth®, or the like.

Also within the network communications module 184 may be an optional web-browsing module 188 through which content items may be browsed, and advertising choices presented and selections made, in the case where the second display application is a web application. In this case, the input module 178 may communicate with the web browsing module to receive and transmit user indications of advertising. The web-browsing module 188 may be implemented in a number of ways, and is capable of executing application code written in HTML and JavaScript, or the like. A web-browsing module 188 implemented in such a way allows the same to be implemented across many platforms, allowing any number of types of second displays to be employed. In some cases, however, special applications, e.g., helper applications, may be employed to communicate with particular proprietary or non-web-based technologies. Where the second display application is non-web-based, and is written in, e.g., native code, the web-browsing module 188 may be replaced with a suitable other module allowing service and content selection or other such functionality.

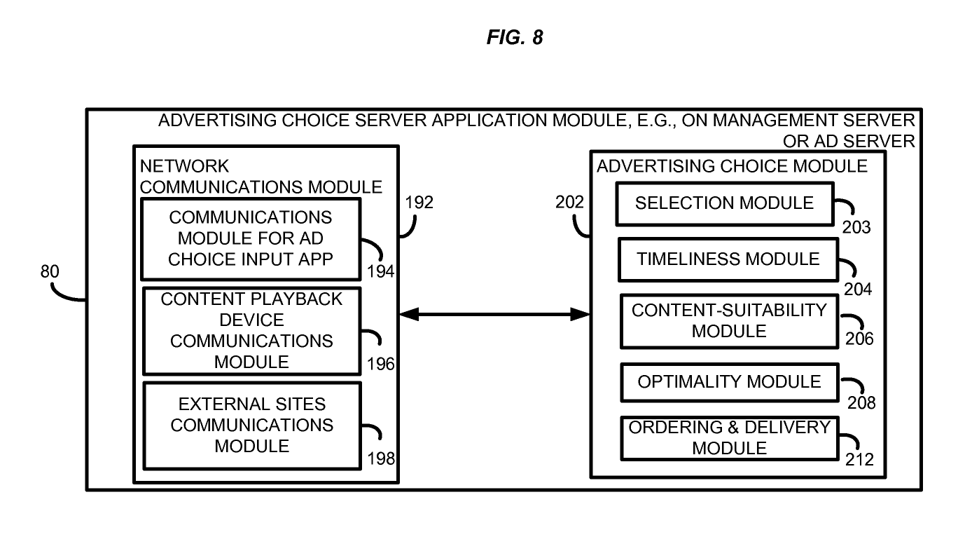

Referring to FIG. 8, a modular implementation of an advertising choice server application module 80 is illustrated which may operate according to the principles described here. The server application module 80 may be implemented on a number of hosting platforms, including on the management server 18, on an advertising server 26, or on other server locations.

The server application module 80 includes a network communications module 192. The network communications module 192 includes a communications module 194 for an ad choice application, which may be employed to communicate with one or more second displays running ad choice applications or with an ad choice application running on a content playback device. The network communications module 192 further includes a content playback device communications module 196, which may be employed to communicate with a content playback device, e.g., to deliver ads thereto along with content items as provided by a content server. The network communications module 192 may further include an external sites communications module 198, which may be employed to communicate with external sites such as social networking sites, online shopping sites, and the like. In this way, user data may be received from such sites for use in informing ad choices.

The server application module 80 further includes an advertising choice module 202. The advertising choice module 202 may include one or more modules which serve to select ads from a database of the same based on applied criteria or direct user selection.

The advertising choice module 202 includes a selection module 203. The selection module 203 may be employed to compare criteria, expressed as metadata, against metadata in ads stored in the database, to develop a set of ads that meet the criteria. The selection module 203 may receive the criteria from category and subcategory indications from a user, keywords, direct ad choices, and the like. Criteria will generally change as user data changes or as a user continues to select ads over time, with a latest or current set of such data or criteria being that which informs ad choice at any given time.

A number of modules may be provided to filter out undesired ads and/or to select new ads. For example, a timeliness module 204 may be employed to, e.g., filter out ads that are no longer timely so that the same are not displayed when a user-recorded content item is played back. A content-suitability module 206 may be employed to determine if an ad to be displayed is suitable for a content item being watched. An optimality module 208 may be provided to determine if an ad, forming part of a user-recorded broadcast of a content item, is suboptimal given user activity subsequent to the recording of the content item. Such activity may include subsequent content item and ad choices, subsequent changes or additions to user data from external sites, subsequent changes in user preferences and interests, and the like. The modules 204, 206, or 208 may be employed to filter the undesired ads as well as to perform the replacement, or a separate module may be provided to perform the replacement.

An ordering and delivery module 212 may be employed to order or prioritize ads selected by module 203 according to a desired scheme, and to deliver or arrange for delivery of the ordered ads to a content playback device through the content playback device communications module 196. It is noted that the ordering functionality of module 212 may also be performed, in whole or in part, by module 203.

It is noted that the above modules within the second display and servers may be implemented in a number of ways. Typically, the same will be implemented within the context of a laptop computer, a tablet computer, a smart phone, or the like. In some cases, module functions may overlap, or module functions may be shared between a second display and a server. Other module functions will also be understood.

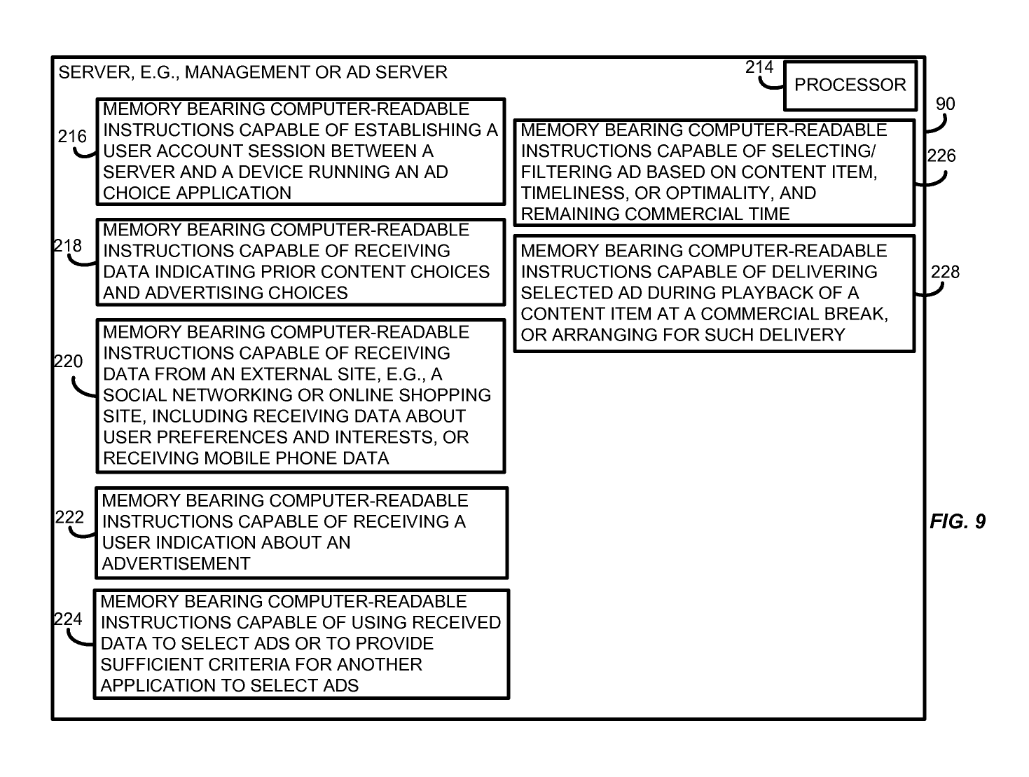

Referring to FIG. 9, an implementation of a server 90 is illustrated which may operate according to the principles described here. The server may be, e.g., a management server, an ad server, or the like. The steps performed by the memories within the server 90 are described in greater detail above. The server 90 includes a processor 214. The server 90 further includes memory 216 bearing computer-readable instructions capable of establishing a user account session between the server and a device running an ad choice application, e.g., a content playback device controlled by a remote control, a second display, or the like. The server 90 further includes memory 218 bearing computer-readable instructions capable of receiving user data indicating prior content choices and advertising choices. In so doing, e.g., the memory 218 may receive data from the management server or the ad server. The server 90 further includes memory 220 bearing computer-readable instructions capable of receiving data from an external site, e.g., a social networking site or an online shopping site. The memory 220 may further be employed to receive data about user preferences and interests, e.g., from the social networking site or from the management server, or by receiving data such as scanned barcodes of products from a mobile phone camera.

The server 90 further includes memory 222 bearing computer-readable instructions capable of receiving a user indication about an ad. The user indication may be, e.g., category/subcategory information or a direct user choice of an ad. The server 90 further includes memory 224 bearing computer-readable instructions capable of using the received data to select ads or to provide sufficient criteria for another application to select ads. The server 90 further includes memory 226 bearing computer-readable instructions capable of selecting or filtering an ad based on a content item, the timeliness of the ad, the optimality of the ad, and the remaining time in the commercial break. In so doing, the memory 226 can replace the ad or arrange for its replacement. The server 90 further includes memory 228 bearing computer-readable instructions capable of delivering the selected ad to a content playback device, or arranging for its delivery, at the appropriate time in the commercial break.

Any given memory described above may be represented by several distinct physical memories, and in the same way the memories may be combined into a single physical memory, and the memories are generally addressable by physical or logical addresses. Various communications modules may be employed to, e.g., receive scanned barcode data indicating product interest, and so on. It is also noted that second displays may be implemented in terms of such memories, and the same may include appropriate functionality. Suitable computing environments may also be implemented as part of cloud architectures.

Systems and methods have been disclosed that allow improvement of the user experience of the IPTV without adding to the hardware costs of the unit. As disclosed above, users may employ the system and method to register advertising choices and in this way make presented advertising highly relevant. The advertising choices may be registered on a second display, thus not interrupting content playback on a content playback device such as an IPTV.

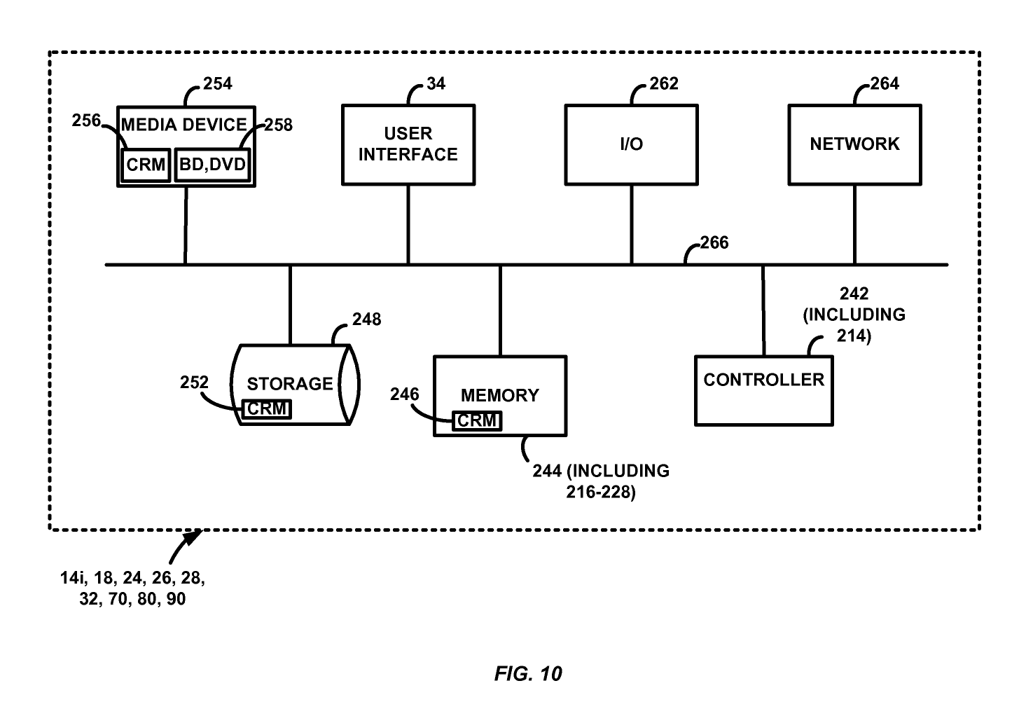

One implementation includes one or more programmable processors and corresponding computing system components to store and execute computer instructions, such as to execute the code that provides the second display or various server functionality, e.g., that of the management server 18 content server 24, ad server 26, as well as for browsing. Referring to FIG. 10, a representation of an exemplary computing environment for a second display or for any of the servers is illustrated.

The computing environment includes a controller 242, a memory 244, storage 248, a media device 254, a user interface 34, an input/output (I/O) interface 262, and a network interface 264. The components are interconnected by a common bus 266. Alternatively, different connection configurations can be used, such as a star pattern with the controller at the center.

The controller 242 includes a programmable processor and controls the operation of the second display or servers and their components. The controller 242 loads instructions from the memory 244 or an embedded controller memory (not shown) and executes these instructions to control the system.

Memory 244, which may include non-transitory computer-readable memory 246, stores data temporarily for use by the other components of the system, and the same may include memories 216-228 as discussed above. In one implementation, the memory 244 is implemented as DRAM. In other implementations, the memory 244 also includes long-term or permanent memory, such as flash memory and/or ROM.

Storage 248, which may include non-transitory computer-readable memory 252, stores data temporarily or long-term for use by other components of the second display and servers, such as for storing data used by the system. In one implementation, the storage 252 is a hard disc drive or a solid state drive.

The media device 254, which may include non-transitory computer-readable memory 256, receives removable media and reads and/or writes data to the inserted media. In one implementation, the media device 254 is an optical disc drive or disc burner, e.g., a writable Blu-ray® disc drive 258.

The user interface 34 includes components for accepting user input, e.g., the user indications of advertising from the user of the second display, and presenting advertising choices and categories to the user. In one implementation, the user interface 34 includes a keyboard, a mouse, audio speakers, and a display. The controller 242 uses input from the user to adjust the operation of the second display or servers.

The I/O interface 262 includes one or more I/O ports to connect to corresponding I/O devices, such as external storage or supplemental devices, e.g., a printer or a PDA. In one implementation, the ports of the I/O interface 262 include ports such as: USB ports, PCMCIA ports, serial ports, and/or parallel ports. In another implementation, the I/O interface 262 includes a wireless interface for wireless communication with external devices. These I/O interfaces may be employed to connect to one or more content playback devices.

The network interface 264 allows connections with the local network and optionally with content playback device 12 and includes a wired and/or wireless network connection, such as an RJ-45 or Ethernet connection or “Wi-Fi” interface (802.11). Numerous other types of network connections will be understood to be possible, including WiMax, 3G or 4G, 802.15 protocols, 802.16 protocols, satellite, Bluetooth®, or the like.

The second display and servers may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Various illustrative implementations of the present invention have been described. However, one of ordinary skill in the art will recognize that additional implementations are also possible and are within the scope of the present invention. For example, the advertising choices system may be provided apart from any particular content item playback, e.g., such as when shopping online or browsing external sites, e.g., when browsing transactions like video rentals or home shopping purchases on the second display, where ads for videos or products may be delivered. Advertising choices may also accompany played-back content items that are resident within the local network, e.g., content stored on a DVR or Blu-ray® player.

While implementations of the system and method have been described as using user indications or user data, both may be employed together to generate highly specific ad choices. For example, user data and user indications such as category information may be employed to generate potential ads, followed by a user choice to select final ads for display.

While implementations of the system and method have been described for use in initial broadcasts of content items as well as for playbacks of user-recorded content items, it will be understood that combinations or hybrids of these situations are also envisioned. For example, a user may begin watching a user-recorded content item prior to the completion of its initial broadcast. By fast forwarding, a user may eventually view content that is part of the initial broadcast, e.g., may “catch up” to the live broadcast. The system and method may be employed to provide user-selected ads in both portions of the content viewing.

The advertising choice system, where implemented to advertise digital content, may be made specific to the set of content playback devices associated with the user account or to another user. In this way, users may be presented with advertising for content items appropriate for their account or for their friends' accounts. Various geolocation methods may be employed for this purpose as well, i.e., to make ads specific to geographic location, e.g., a user may choose an ad for a particular car and the advertising choice application may deliver an ad from a local dealer. A server can harvest and mine data on a location basis to provide initial ad choices for users residing in the same location or nearby locations. In the same way, a server may keep track of the date, time of day, and time zone of when ad choices are made. The server may further keep track of the duration a user watches an ad, as duration may be a key in determining the relationship between the user's ad choice and their actual ad viewing interest, forming a weighted user interest. Using the above data, an ad server can build a profile of a user's ad choosing activity on a periodic basis, e.g., daily, weekly, monthly, and so on, per one or more locations. For users that have not expressed ad preferences, the ad server can develop a profile to deliver initial ad choices based on analogy to users in the same or nearby locations. Geolocation may work in the opposite direction as well, e.g., to provide demographic information to advertisers.

The user-based or user-selected advertising may be accompanied by an incentive to watch the ad, e.g., the provision of coupons. In this way, users may be enabled to select ads based on which advertisers have coupons available. The system may interface with various membership sites, such as those associated with travel clubs, stores, and the like.

Where the ad selection is performed by a user without any contemporaneous content playback, the selection may be performed by an appropriate user interface on the content playback device.

Ads are generally provided from an ad server; however, certain ads may also be stored in a local storage on the local network. In this case, a signal may be sent from the management server or ad server to cause the ad to be sent from the local storage to the content playback device. This implementation may be particularly advantageous for ads that are highly preferred by a user, or that the system determines may be highly preferred and which are consequently downloaded to local storage ahead of time.

While the presentation of ads has been disclosed to be based on user preferences expressed in the ad choice application, it is noted that categories and subcategories of ads, as well as preferred styles of ads, e.g., humorous or fact-filled, can be chosen in a user preference menu, as part of the overall user profile associated with the management server or with another controlling service application. For example, an IPTV device associated with such an account could have advertising shown during content playback on that IPTV that is chosen based on these user preferences. The user could specify these account preferences in a number of ways, including through a website or an application running on a device, such as on the IPTV device itself, that is associated with the account. The advertising preferences may also include information inferred from other user actions, such as the content choices that they make. For example, a user that watches a lot of science fiction content may have an inference in their advertising preferences that they prefer science-fiction-themed ads.

Accordingly, the present invention is not limited to only those implementations described above.

1. A server-based method of selecting an ad for playback on a content playback device during a commercial break of a content item, comprising:
i. receiving information about a content item, the content item having defined at least one commercial break;
ii. receiving a user indication of an ad or user data;
iii. selecting an ad based on the received user indication or user data; and
iv. sending a signal to cause the selected ad to be delivered to the content playback device for playback during a commercial break in the content item.

2. The method of claim 1, wherein the receiving a user indication of an ad includes receiving a choice of an ad from a plurality of displayed ads, and wherein the selecting an ad based on the received user indication includes selecting an ad corresponding to the choice.

3. The method of claim 1, wherein the selecting an ad is based on both a received user indication and user data.

4. The method of claim 1, wherein the receiving information and the receiving a user indication includes receiving information from a user of the content playback device.

5. The method of claim 1, in which the steps of receiving information and receiving a user indication of an ad or user data are facilitated by utilization of a second display.

6. The method of claim 1, further comprising causing playback of the content item with the selected ad played back during a commercial break.

7. The method of claim 1, wherein the selecting an ad further comprises selecting the ad based on the received information about the content item.

8. The method of claim 1, wherein the user indication of an ad or user data is received before the information about the content item, and further comprising:
i. determining if the selected ad is suitable for the content item, and if so, sending a signal to cause the selected ad to be delivered, and if not, sending a signal to cause a replacement ad to be delivered; or
ii. selecting the ad based on an additional criterion, the additional criterion being metadata associated with the content item.

9. The method of claim 1, wherein the receiving a user indication of an ad or user data includes receiving a user indication of an ad during a time when a first ad is being played back on the content playback device, and further comprising:
i. selecting a second ad based on the received user indication and a time remaining in the commercial break; and
ii. causing the selected second ad to be delivered to the content playback device.

10. The method of claim 9, further comprising causing playback of the first ad to stop prior to the causing the selected second ad to be delivered to the content playback device.

11. The method of claim 1, wherein the receiving a user indication of an ad or user data further comprises receiving a user indication of an ad or user data from a social networking site.

12. The method of claim 1, wherein the receiving a user indication of an ad or user data further comprises receiving user data of a type selected from the group consisting of: a user purchasing or browsing history, a prior user ad choice, a prior user indication of an ad, a previously-viewed content item, a user preference or interest, a barcode scanned by the user, a preferred ad length, an average ad length previously viewed or selected by a user, a date, time of day, or time zone of a user, a user location, or a combination of the above.

13. The method of claim 1, wherein the receiving a user indication of an ad or user data further comprises receiving a user indication of an ad or user data from a second display, the second display at least partially configured to control content item presentation on the content playback device.

14. The method of claim 13, wherein the second display is at least partially configured to control content item presentation on the content playback device through a proxy server.

15. The method of claim 13, wherein the receiving a user indication of an ad or user data occurs during playback of a content item on the content playback device.

16. The method of claim 1, wherein the receiving a user indication of an ad or user data occurs prior to playback of the content item on the content playback device, and wherein the receiving a user indication of an ad or user data further comprises receiving user indication of an ad or user data from a user interface on the content playback device.

17. The method of claim 1, wherein the receiving a user indication of an ad includes receiving category information from a user, the category information indicating categories of products or services.

18. The method of claim 1, wherein the receiving a user indication of an ad includes receiving keyword information from a user, the keyword information indicating products or services.

19. The method of claim 1, further comprising receiving a notification that a user is playing back a recorded content item at a current time, and further comprising:
i. determining if ads in the recorded content item are timely, and if ads in the recorded content item are not timely, selecting one or more ads that are timely to be selected and causing the one or more timely ads to be delivered to the content playback device to replace the untimely ads, an ad being timely when included time-sensitive content has not expired as of the current time; or
ii. determining if ads in the recorded content item are optimal, an ad being optimal when selected on a basis of user indications, user data, or using criteria as of the current time, and if ads in the recorded content item are suboptimal, selecting one or more ads that are optimal and causing the one or more optimal ads to be delivered to the content playback device to replace the suboptimal ads.

20. A non-transitory computer-readable medium, comprising instructions for causing a computing device to implement the method of claim 1.

21. A server-based method of selecting an ad for playback on a content playback device during playback of a recorded content item, comprising:
i. receiving a notification from a user of the content playback device that the user is playing back a recorded content item at a current time;
ii. determining if ads in the recorded content item are timely, and if ads in the recorded content item are not timely, selecting one or more ads that are timely and causing the one or more selected timely ads to be delivered to the content playback device to replace the untimely ads, an ad being timely when included time-sensitive content has not expired as of the current time; or
iii. determining if ads in the recorded content item are optimal, an ad being optimal when selected on a basis of user indications, user data, or using criteria as of the current time, and if ads in the recorded content item are suboptimal, selecting one or more ads that are optimal and causing the one or more selected optimal ads to be delivered to the content playback device to replace the suboptimal ads.

22. The method of claim 21, further comprising receiving a user indication of an ad or user data, and wherein the one or more ads that are timely or the one or more ads that are optimal are selected based at least in part on the recorded content item and on the received user indication of an ad or user data.

23. The method of claim 22, further comprising receiving user data of a type selected from the group consisting of a user purchasing or browsing history, a prior user ad choice, a prior user indication of an ad, a previously-viewed content item, a user preference or interest, user data from an external site, a barcode scanned by the user, or a combination of the above.

24. The method of claim 22, further comprising receiving the user indication of an ad or user data from a second display, the second display at least partially configured to control content item presentation on the content playback device.

25. A non-transitory computer-readable medium, comprising instructions for causing a computing device to implement the method of claim 21.

26. A second display system for providing advertising based on user choice, comprising:
i. an input module configured to receive a user indication of an ad;
ii. a second display advertising choice module configured to receive and store user data about online browsing or shopping and to receive the user indication from the input module; and
iii. a network communications module configured to receive data from the second display advertising choice module and transmit the received data to a management server or ad server.

27. A server system for providing advertising based on user choice, comprising:
i. a network communications module configured to receive and transmit data, the network communications module including:
1. a communications module configured to communicate with an ad choice application , the communications module configured to receive a user indication of an ad and configured to transmit at least potential ad choices or ad categories;
2. a content playback device communications module configured to communicate and deliver or cause to be delivered ads for playback on a content playback device; and
3. an external site communications module configured to communicate with and receive user data from at least one external site;
ii. an advertising choice server module configured to receive a user indication of an ad or user data from the network communications module and to either select an ad based on the received data or to create criteria sufficient for selection of one or more ads, the advertising choice server module including a content suitability module configured to determine if an ad is suitable for playback during playback of a content item; and
iii. an ordering and delivery module configured to order ads based at least partially on the user indication of an ad or the user data or both, and to deliver or cause to be delivered one or more of the ordered ads to a content playback device through the content playback device communications module.

28. The system of claim 27, wherein the advertising choice server module further comprises a timeliness module configured to, upon playback of a recorded content item at a current time, determine if a recorded ad is timely and to replace the ad if it is not timely, an ad being timely when included time-sensitive content has not expired as of the current time.

29. The system of claim 27, wherein the advertising choice server module further comprises an optimality module configured to, upon playback of a recorded content item at a current time, determine if a recorded ad is optimal, an ad being optimal when selected on a basis of user indications, user data, or using criteria as of the current time, and to replace the ad if it is suboptimal.

30. The system of claim 27, wherein the server is a management server or an advertising server.

31. The system of claim 27, wherein the external site communications module is configured to communicate with a social networking site or an online shopping site.

32. The system of claim 31, wherein the external site communications module is configured to receive a feed from a user profile on the social networking site.

33. The system of claim 32, wherein the feed includes data selected from the group consisting of: preferences and interests, groups, friends' interests and preferences, and combinations of these.

34. The system of claim 31, wherein the external site communications module is configured to provide a feed to a user profile on the social networking site.

35. A server system for providing advertising to a user based on user choice, comprising:
i. memory bearing computer-readable instructions capable of establishing a user account session between a server and a device running an ad choice application;
ii. memory bearing computer-readable instructions capable of receiving user data or a user indication about an ad;
iii. memory bearing computer-readable instructions capable of receiving user data from an external site;
iv. memory bearing computer-readable instructions capable of using the received user data or user indication to select an ad; and
v. memory bearing computer-readable instructions capable of delivering, or causing to be delivered, the selected ad to a content playback device associated with the user account during playback of a content item.
